(19) United States
(12) Patent Application Publication
(10) Pub. No.: US 2020/0366176 A1
(43) Pub. Date: Nov. 19, 2020

(54) MACHINE ASSEMBLY, ELECTRIC MACHINE AND VEHICLE

(71) Applicant: Rolls-Royce Deutschland Ltd & Co KG, Blankenfelde-Mahlow (DE)

(72) Inventors: Behnam Houshmand, München (DE); Christian Loesch, Erlangen (DE); Andreas Reeh, Nürnberg (DE); Markus Sons, Nürnberg (DE)

(21) Appl. No.: 16/966,574

(22) PCT Filed: Feb. 7, 2019
(86) PCT No.: PCT/EP2019/052966

§ 371 Date: Jul. 31, 2020

(30) Foreign Application Priority Data
Feb. 8, 2018 (DE) 10 2018 201 985.1

(51) Int. Cl. H02K 21/14; B64D 27/24

(52) U.S. Cl. CPC H02K 21/14; B64D 2027/026; H02K 2213/12; B64D 27/24

(57) ABSTRACT

The machine assembly includes a plurality of electric machines, wherein rotors and/or stators of the electric machines are mechanically coupled to one another. The electric machine serves, in particular, to constitute a machine assembly and includes a housing for a rotor and/or stator, wherein the housing has a respective first and second mechanical connection element, wherein first and second mechanical connection elements correspond to one another. The vehicle may be an electric and/or hybrid-electric vehicle. The vehicle has a machine assembly and/or at least one electric machine, in particular a drive having the machine assembly or the electric machine.

The present patent document is a § 371 nationalization of PCT Application Serial No. PCT/EP2019/052966, filed Feb. 7, 2019, designating the United States, which is hereby incorporated by reference, and this patent document also claims the benefit of German Patent Application No. 10 2018 201 985.1, filed Feb. 8, 2018, which is also hereby incorporated by reference.

### TECHNICAL FIELD

The disclosure relates to a machine assembly, an electric machine, and to a vehicle, in particular, an electric and/or hybrid-electric aircraft.

### BACKGROUND

Electric propulsion units of vehicles such as hybrid-electric aircraft require electric machines with a high ratio of drive power to mass (power density in relation to mass). Furthermore, such vehicles occasionally require levels of drive power of several 100 kilowatts (kW) up to the megawatt range.

Permanently excited motors have the presently highest power density for electric propulsion units, wherein it is possible to attain power levels between 10 kW and 1 megawatts (MW).

There however appears to be difficulty in further increasing the power density or the absolute power of permanent-magnet-excited motors or generators.

Furthermore, in particular in the case of aircraft with electric or hybrid-electric propulsion, the required lightweight construction imposes restrictions in terms of structural dynamics. Additionally, there are high requirements with regard to the reliability of electric drives of vehicles, in particular in the aviation industry, and high requirements with regard to a degree of compactness that must be attained.

In some cases, these requirements are difficult to satisfy, especially as permanent-magnet-excited motors are developed individually for a specific application and power class, such that new application purposes may consume a large amount of development resources.

### SUMMARY AND DESCRIPTION

It is therefore an object of the disclosure to provide a machine assembly which may be used for an electric or hybrid-electric propulsion unit of a vehicle, (e.g., an aircraft). In particular, it is the intention for resource-conserving development for new specifications and a high absolute power and a high-power density to be attainable with the machine assembly.

It is furthermore an object of the disclosure to create an electric machine with which a machine assembly may be realized. It is furthermore an object of the disclosure to create an improved vehicle, (e.g., an electric and/or hybrid-electric aircraft), which may be electrically propelled in an improved manner.

This object of the disclosure is achieved by a machine assembly, by an electric machine, and by a vehicle as disclosed herein. The scope of the present disclosure is defined solely by the appended claims and is not affected to any degree by the statements within this summary. The present embodiments may obviate one or more of the drawbacks or limitations in the related art.

The machine assembly includes a multiplicity of electric machines, in which rotors of the electric machine are mechanically coupled to one another and, e.g., stators of the electric machine are mechanically coupled to one another. In the context of this application, this means that either the rotors of the electric machines are mechanically coupled to one another or that the rotors of the electric machines are coupled to one another and the stators of the electric machines are mechanically coupled to one another.

Owing to the mechanical coupling of the multiplicity of electric machines, the electrical power of the machine assembly is defined by the sum of the electrical powers of the individual electric machines of the machine assembly. According to the disclosure, the development costs for high power classes may be considerably reduced, because the electric machines of the machine assembly may be easily mechanically coupled to one another in order to provide the desired power. The electric machines of the machine assembly are expediently of similar design to one another, e.g., with the same electrical characteristic variables, and, in certain examples, identical to one another. Correspondingly, the desired power may be easily obtained by multiplication of the individual power of an electric machine of the machine assembly, such that it is merely necessary for the corresponding number of electric machines to be present in the machine assembly. The development of machine assemblies is consequently possible without significant expenditure of time and resources.

According to the disclosure, an electrical connection of the electric machines to one another is superfluous and is in particular not provided.

Furthermore, the machine assembly is of particularly reliable and fail-safe design. The presence of a multiplicity of electric machines gives rise to a redundant design of the machine assembly, such that, in the event of a failure of one electric machine, the at least one further or the multiple further electric machines of the machine assembly provide the functionality thereof. In particular, by the machine assembly, it is not necessary for multiple electric machines to additionally be provided separately in the system architecture for example of an electric vehicle such as in particular an aircraft, such that the overall mass of the system architecture, for example, of a propulsion unit of the electric vehicle, may be kept low.

In the machine assembly, the electric machines may be permanent-magnet-excited machines, (e.g., motors and/or generators). Permanent-magnet-excited machines advantageously have an adequately high power density in relation to mass, such that the machine assembly is advantageously usable for power-critical and mass-critical applications, in particular for electric vehicles such as a hybrid-electric aircraft.

In the machine assembly, the rotors and, e.g., also the stators are expediently coupled in series. In this way, the rotors and/or stators may be coupled to one another in a particularly simple manner. In particular, the rotors may, in the case of their series coupling to one another, be arranged as or with or on a common shaft.

In a refinement of the machine assembly, the coupled rotors are handleable as a single piece, (e.g., handleable as a single part), and may be formed with or on or as a single-piece shaft, (e.g., single-part shaft). In this refinement of the disclosure, the passive mass may be kept sufficiently low. It is advantageously possible for the dynamic behavior of the single-piece shaft to be kept in a practicable range. The machine assembly may particularly advantageously be of compact form, because one or more dimensions, (e.g., the diameter), of the machine assembly need not necessarily be configured to be larger in relation to individual electric machines of the machine assembly. The machine assembly may be of such compact form that the machine assembly fits inside a nacelle of an electric or hybrid-electric aircraft.

In the machine assembly, the rotors may be in each case surrounded by the stator and/or in each case led through the stator.

In the machine assembly, the operating rotational speed may be at least 1000 revolutions per minute and/or at most 3000 revolutions per minute. In particular, with the latter parameters of this refinement, it is possible to omit a maintenance-intensive transmission with a fast-rotating drive.

In the machine assembly, the rotors are expediently coupled to one another in positively locking and/or non-positively locking fashion, in particular, by clamping connections, and/or the stators are coupled to one another in positively locking and/or non-positively locking fashion, in particular, by clamping connections. In this way, the rotors and/or stators of the electric machines may be mechanically joined to one another similarly to clamped modules.

In the machine assembly, the electric machines may have an operating power of in each case at least 30 kilowatts, at least 100 kilowatts, and/or at most 2 megawatts, (e.g., at most 1 megawatt). With such electric machines, it is possible to easily realize a machine assembly with an operating power of at least 100 kW, at least 400 kW, and at least 2 megawatts or even 10 megawatts.

The electric machine serves in particular for the construction of a machine assembly as described above. The machine has a housing for in each case one rotor and/or stator of the electric machine, wherein the housing has in each case a first and a second mechanical connecting element, wherein the first and second mechanical connecting element correspond with one another. The first and second connecting element are expediently arranged at mutually averted sides of the housing. In this way, the housings of the electric machines may be of identical form with respect to one another, at least with regard to the connecting elements. It is thus possible in each case for the first connecting element of one machine to be connected to the second connecting element of an adjacent machine and for the in each case second connecting element of one machine to be connected to the first connecting element of an adjacent machine, such that the machines are connectable to form a machine assembly. The first and second connecting element may be formed as clamping connecting elements, such that the housings of the electric machines are connectable to one another in series in the manner of identical clamped modules.

It is self-evident that a connecting element in the context of this application need not necessarily be formed as an additional element which is arranged separately on the housing, but rather the connecting element may also be formed with the housing itself or formed with a part of the housing itself.

The vehicle is in particular an electric and/or hybrid-electric aircraft. The vehicle has a machine assembly as described above and/or at least one electric machine, (e.g., a multiplicity of electric machines), as described above. The vehicle may include a propulsion unit which has a machine assembly of the type or an electric machine of the type or a multiplicity of electric machines of the type.

### BRIEF DESCRIPTION OF THE DRAWINGS

The disclosure will be discussed in more detail below on the basis of the exemplary embodiments illustrated in the drawings.

In the drawings:

FIG. 1 schematically shows an example of an electric aircraft with an electric motor assembly in a perspective illustration.

FIG. 2 schematically shows the electric motor assembly of the aircraft as per FIG. 1 in a perspective illustration.

FIG. 3 schematically shows the electric motor assembly as per FIG. 2 in a longitudinal section.

### DETAILED DESCRIPTION

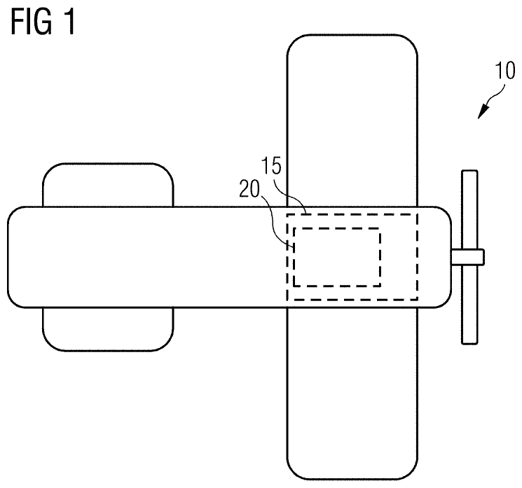

The electric aircraft 10 illustrated in FIG. 1 has a propulsion unit 15 with an electric motor assembly 20. The electric motor assembly 20 is of modular construction, as described below:

The electric motor assembly 20 is assembled from multiple, in the illustrated case six, electric motors 30, which are formed in a manner known per se with a rotor 50 which is guided, so as to be rotatable about an axis A, within a stator 40.

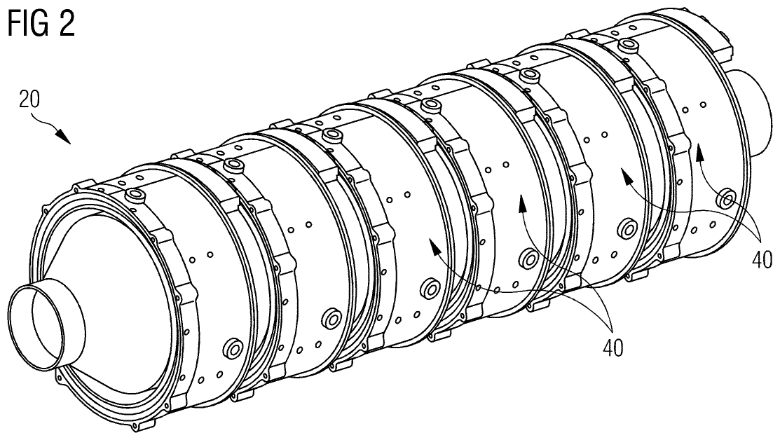

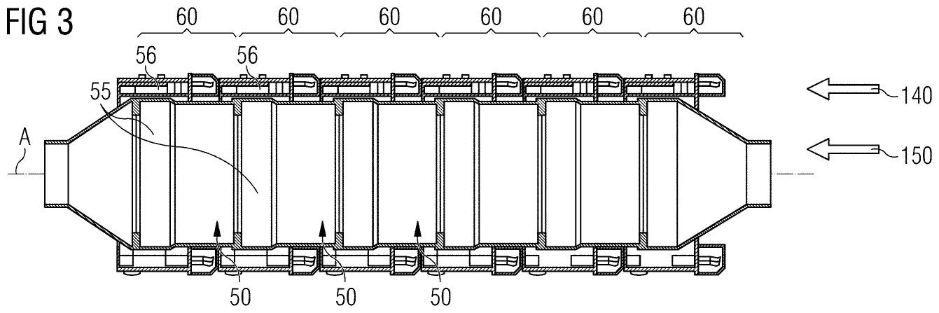

In the electric motor assembly 20 illustrated in FIGS. 2 and 3, both the stators 40 and the rotors 50 are mechanically coupled to one another. For this purpose, in an axial direction around which the rotors 50 are arranged so as to be rotatable, the rotors 50 are mechanically connected to one another, and the stators 40 are mechanically connected to one another, by clamping connections. The clamping connections (not explicitly shown in FIG. 2) are formed in each case by axial ends, which bear against one another, of housings 55 of the rotors 50 and housings 56 of the stators 40, wherein the axial ends correspond with one another in terms of their shape. In the exemplary embodiment shown, the individual stators 40 and rotors 50 are of similar form and may be joined together in any desired number in the manner of clamped modules. In this way, a rotor assembly 150 is formed from the individual rotors 50, which rotor assembly substantially has a cylindrical design and consequently forms a shaft, which is handleable as a single piece, of the motor assembly 20. Correspondingly, a stator assembly 140 of the motor assembly is formed from the individual stators 40 owing to their mechanical connection to one another, which stator assembly has a substantially tubular, cylindrical-shell-shaped design.

The rotor assembly 150 may thus rotate, within the surrounding stator assembly 140, about the axis A.

In further exemplary embodiments which are not separately illustrated, the rotors 50 and the stators 40 are mechanically connected to one another not by clamping connections but in some other way, for example by detent connections or by positively locking or cohesive connections.

Stator assembly 140 and rotor assembly 150 are coupled to one another merely by mechanical connection of the individual stators 40 and rotors 50. A direct electrical connection of the stators 40 to one another or of the rotors 50 to one another is not provided. Thus, in terms of electronics, the individual rotors 50 and the stators 40 respectively surrounding these each constitute individual electric motors 60.

However, the output side of the electric motor assembly 20 is mechanically coupled by the rotors 50 which are mechanically coupled as a rotor assembly 150. The electrical input side of the electric motor assembly 20 is fed from a common electrical source. In this way, the electric motor assembly 20 acts as a single motor, which is made up of the individual electric motors 60 in series.

In the exemplary embodiment illustrated, the electric motor assembly 20 is designed for an operating rotational speed of 2250 revolutions per minute. In the exemplary embodiment illustrated, the individual electric motors 60 are designed for a power of 250 kW. In this way, the electric motor assembly 20 is configured for a power of 1.5 MW. In further exemplary embodiments which are not separately illustrated, the electric motors 60 are designed for other parameters instead of the parameters presented above.

In a further exemplary embodiment, which otherwise corresponds to the exemplary embodiment illustrated, the electric aircraft 10 has a nacelle in which the electric motor assembly 20 is arranged.

In further exemplary embodiments which are not separately illustrated, a generator assembly is provided instead of the electric motor assembly 20. Here, instead of individual electric motors 60, individual generators are in each case mechanically coupled to one another.

Although the disclosure has been illustrated and described in greater detail by the exemplary embodiments, the disclosure is not restricted by these exemplary embodiments. Other variations may be derived herefrom by the person skilled in the art, without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A machine assembly comprising:
a multiplicity of electric machines having machine assembly rotors and stators,
wherein the rotors are mechanically coupled to one another, and
wherein the stators are mechanically coupled to one another.

2. The machine assembly of claim 1, wherein the electric machines are permanent-magnet-excited machines.

3. The machine assembly of claim 1, wherein the rotors and/or the stators are coupled in series.

4. The machine assembly of claim 1, wherein the coupled rotors are handleable as a single piece and are formed with or on a single-piece shaft or as a single-piece shaft.

5. The machine assembly of claim 1, wherein the rotors are surrounded by the stator or are led through the stator.

6. The machine assembly of claim 1, wherein an operating rotational speed of the machine assembly is in a range of 1000 revolutions per minute and 3000 revolutions per minute.

7. The machine assembly of claim 1, wherein the rotors and/or the stators are coupled to one another in positively locking and/or non-positively locking fashion.

8. The machine assembly of claim 1, wherein each electric machine of the multiplicity of electric machines has an operating power in a range of 30 kilowatts and 2 megawatts.

9. An electric machine for construction of a machine assembly, the electric machine comprising:
a rotor;
a stator; and
a housing for the rotor and/or the stator,
wherein the housing has a first mechanical connecting element and a second mechanical connecting element, and
wherein the first mechanical connecting element and the second mechanical connecting element correspond with one another.

10. A vehicle comprising:
a propulsion unit; and
a machine assembly coupled to the propulsion unit, the machine assembly having a plurality of electric machines,
wherein the plurality of electric machines has rotors and stators,
wherein the rotors are mechanically coupled to one another, and
wherein the stators are mechanically coupled to one another.

11. The vehicle of claim 10, wherein the vehicle is an electric aerial vehicle or a hybrid-electric aerial vehicle.

12. The vehicle of claim 11, wherein the electric aerial vehicle or the hybrid-electric aerial vehicle is an aircraft.

13. The machine assembly of claim 2, wherein the permanent-magnet-excited machines are motors and/or generators.

14. The machine assembly of claim 1, wherein the rotors and/or stators are coupled to one another by clamping connections.
